(19) United States
(12) Patent Application Publication
(10) Pub. No.: US 2011/0224969 A1
(43) Pub. Date: Sep. 15, 2011

(54) Method, a Media Server, Computer Program and Computer Program Product For Combining a Speech Related to a Voice Over IP Voice Communication Session Between User Equipments, in Combination With Web Based Applications

(75) Inventors: Catherine Mulligan, Alvsjo (SE); Magnus Olsson, Stockholm (SE); Ulf Olsson, Sollentuna (SE)

(73) Assignee: TELEFONAKTIEBOLAGET L M ERICSSON (PUBL), Stockholm (SE)

(21) Appl. No.: 13/129,828

(22) PCT Filed: Nov. 20, 2009
(86) PCT No.: PCT/SE2009/051313

§ 371 Date: May 18, 2011

Related U.S. Application Data
(60) Provisional application No. 61/116,791, filed on Nov. 21, 2008.

(51) Int. Cl. G10L 15/26; G06Q 30/00; G06F 17/28

(52) U.S. Cl. 704/2; 705/14.73; 704/235; 704/E15.043

(57) ABSTRACT

A media server, a method, a computer program and a computer program product for the media server, are provided for combining a speech related to a voice over IP (VoIP) voice communication session between a user equipment A and a user equipment B, with a web based applications. The method further comprising the media server performing the following steps: capturing the speech related to the VoIP voice communication session; converting the speech to a text; creating a contextual data by adding a service from the web based applications using the text. The media server comprises a capturing unit for capturing the speech of the VoIP voice communication session; a converting unit for converting the speech to text; a creating unit for creating a contextual data by adding services from web based applications using said text. Further a computer program and a computer program product are provided for the media server.

### TECHNICAL FIELD

The invention relates to a field of telecommunication, and more particularly to a media server, method, computer program and computer program product for combining a speech related to a voice over IP (VoIP) voice communication session between user equipments, with a web based applications.

### BACKGROUND

A network architecture called IMS (IP Multimedia Subsystem) has been developed by the 3^{rd} Generation Partnership Project (3GPP) as a platform for handling and controlling multimedia services and sessions, commonly referred to as an IMS network. The IMS network can be used to set up and control multimedia sessions for “IMS enabled” terminals connected to various access networks, regardless of the access technology used. The IMS concept can be used for fixed and mobile IP terminals.

Multimedia sessions are handled by specific session control nodes in the IMS network, e.g. the nodes P-CSCF (Proxy Call Session Control Function), S-CSCF (Serving Call Session Control Function), and I-CSCF (Interrogating Call Session Control Function). Further, a database node HSS (Home Subscriber Server) is used in the IMS network for storing subscriber and authentication data.

The Media Resource Function (MRF) provides media related functions such as media manipulation (e.g. voice stream mixing) and playing of tones and announcements. Each MRF is further divided into a Media Resource Function Controller (MRFC) and a Media Resource Function Processor (MRFP). The MRFC is a signalling plane node that acts as a SIP (Session Initiation Protocol) User Agent to the S-CSCF, and which controls the MRFP. The MRFP is a media plane node that implements all media-related functions.

A Back-to-Back User Agent (B2BUA) acts as a user agent to both ends of a SIP call. The B2BUA is responsible for handling all SIP signalling between both ends of the call, from call establishment to termination. Each call is tracked from beginning to end, allowing the operators of the B2BUA to offer value-added features to the call. To SIP clients, the B2BUA acts as a User Agent server on one side and as a User Agent client on the other (back-to-back) side.

The IMS network may also include various application servers and/or be connected to external ones. These servers can host different multimedia services or IP services.

One basic application of the IMS network is voice. This service has some problems today. One example is that it is necessary for the users to speak the same language. It is also not possible to combine to integrate the voice service with other services in a convenient way.

There is a solution for “real time translation” i.e. U.S. Pat. No. 6,980,953B1, however, this system is merely designed to link in the right translator (i.e. physical human being) into the voice flow. The human being then provides the translation for the two end-users. This is one possible solution, and while it bypasses many of the technical problems associated with translation, it is limited to the availability of human translators to sit in a call centre and answer phones. It is also significantly more expensive than the system described below, which will function well for most users. For significant business negotiations or other situations where poor translation may expose parties to legal liability, a human translator is a necessity.

With the evolution of the Internet, IMS network and radio networks, end-users are faced with the problem of how to manage their content and their communications effectively. Currently, there are many different solutions for the storage, maintenance, search and processing of text-based information. Also, many end-users are now based in less developed nations, where literacy levels are low: in effect they are excluded from the knowledge that forms the text-based corpora of the Internet. Providing access to mobile broadband networks therefore also requires the creation of effective means of storing, exchanging, processing and searching the voice communications of these end-users. In effect, there is a strong need for a ‘voice-based Internet’, allowing end-users access to knowledge that is relevant and important to their personal, economic and social lives.

The IMS network is a platform designed to be used in conjunction with other Internet services using Mobile Broadband handsets and networks. There is currently no method to effectively combine, or ‘mash-up’ the content (voice) of an ongoing IMS-based voice call with other IP services, for example services on the Internet. There is currently no prior art related to taking the “content” of an end-user's conversation (i.e. the topic of the conversation, what the end-users are actually talking about) and combining that with other services, e.g. internet services that are available on the Internet. There is some prior art related to real-time translation, e.g. WO2009011549A2, however this solution is embedded in the mobile device and uses WAP. More importantly, this invention does not capture what the end-user is talking about; it merely provides a translation of the conversation.

Also, there is currently no means for an end-user to capture the context of actual conversation content of their voice services and save them in a form that is similar to the Internet; that allows e.g. one person to leave a voice-based (or video-based) ‘web-page’ which another person can ‘search’ for and ‘read’. Similar limitations exist in other voice over IP (VoIP) related technologies such as Skype technologies.

### SUMMARY

The objective of the invention is to provide a translation application for e.g. translations and subtitles of the ongoing voice conversation and/or IPTV broadcast to the end-users so they can manage storage, maintenance, search and process voice based content. This is achieved by the different aspects of the invention described below.

In an aspect of the invention, a method, in a media server is provided, for combining a speech related to a voice over IP (VoIP) voice communication session between a user equipment A (UE-A) and a user equipment B (UE-B), with a web based applications, the method further comprising the media server performing the following steps:
capturing the speech related to the VoIP voice communication session;
converting the speech to a text;
creating a contextual data by adding a service from the web based applications using the text.

In an embodiment of the method, the contextual data is a subtitle, the method further comprising the step of sending the subtitle to the UE-B.

In an embodiment of the method, the contextual data is a translation, the method further comprising the step of sending the translation to the UE-B.

In an embodiment of the method, the method further comprises the steps of
converting the translation into a translated speech;
sending the translated speech to the UE-B.

In an embodiment of the method, the step of creating a contextual data comprises the sub-steps of
sending the text to an advertising application server;
receiving the contextual text in the form of an advertisement; and
sending the advertisement to UE-B and/or UE-A.

In an embodiment of the method, the UE-A is a set top box.

In an embodiment of the method, there are provisions for providing the contextual data in real-time to the UE-A and/or UE-B.

In an embodiment of the method, there are provisions for providing a real-time output of the subtitles in parallel with an IMS voice session.

In an embodiment of the method, there are provisions for of providing a real-time output of the translation in parallel of an IMS voice session.

In an embodiment of the method, there are provisions for providing a real-time output of the translated speech to the UE-B.

In an embodiment of the method, there are provisions for creating a contextual data and the method according to this embodiment further comprises the sub-steps of
sending the text to a location based services application server;
receiving the contextual text in the form of a location information; and
sending the location information to the UE-B and/or UE-A.

In an embodiment of the method, there are provisions for storing the contextual data in a web technology application server.

In an embodiment of the method, there are provisions for:
requesting a search of the content of the contextual data from a search unit;
receiving a list of web page links from the search; and
outputting and returning to the UE-A and/or UE-B with the list of web page links from the search.

In an embodiment of the method, there are provisions for storing the contextual data and/or the web page links as an Internet text based corpora/web viewing format, wherein the step of storing may be done in a web technology application server and/or a storage unit and/or a media server storage unit.

In an embodiment of the method, there are provisions for
retrieving the contextual data from the web technology application server; and
converting the contextual data into the translated speech for playback for the UE-A and/or UE-B.

In another aspect of the invention a media server is provided, for combining a speech related to the voice over IP (VoIP) voice communication session between the user equipment A (UE-A) and the user equipment B (UE-B), with the web based applications, the media server comprising:
a capturing unit for capturing the speech of the VoIP voice communication session;
a converting unit for converting the speech to text;
a creating unit for creating a contextual data by adding the service from web based applications using said text.

In one embodiment of the media server, the media server comprises:
a subtitle unit for converting the text to subtitles; and
an output unit for sending the subtitle to the UE-B.

The media server may in one embodiment comprise:
a translation unit for converting the text to a translation; and
an output unit for sending the translation to the UE-B.

The media server may comprise:
a speech unit for converting the translation into the translated speech; and
an output unit for sending the translation to the UE-B.

The media server may comprise:
an advertisement unit for sending the text to an advertising application server;
an input unit for receiving the contextual text in the form of an advertisement; and
an output unit for sending the advertisement to UE-B and/or UE-A.

In one embodiment of the media server, the UE-A may be the set top box.

The media server may provide the contextual data in real-time to the UE-A and/or UE-B.

The media server may provide a real-time output of the subtitles in parallel of an IMS voice session.

The media server may provide a real-time output of the translation in parallel of an IMS voice session.

The media server may provide a real-time output of the translated speech to the UE-B.

The media server may in one embodiment comprise:
a location based unit for sending the text to a location based services application server;
an input unit for receiving the contextual text in the form of a location information; and
an output unit for sending the location information to the UE-B and/or UE-A.

The media server may comprise the output unit for sending the contextual data for storage on a web technology application server and/or storage unit and/or a media server storage unit.

The media server may in one embodiment comprise:
the output unit for requesting a search of the content of the contextual data from a search unit;
the input unit for receiving a list of web page links from the search; and
the output unit for outputting and returning to the UE-A and/or UE-B with the list of the web page links from the search.

The media server may in one embodiment comprise the output unit for sending the contextual data and/or the list of web page links as an internet based corpora/web viewing format for storage on the web technology application server.

The media server may in one embodiment comprise:
the input unit for retrieving the contextual data from the web technology application server; and
the speech unit for converting the contextual data into the translated speech for playback for the UE-A and/or UE-B.

In another aspect of the invention, there is a computer program comprising computer readable code means which when run on the media server causes the media server to:
capture a speech related to a voice over IP (VoIP) voice communication session;
translate the speech to a text;
create a contextual data by adding the service from a web based applications using the text.

In an embodiment of the computer program, the computer readable code means which when run on the media server causes the media server to perform the step of converting the text to a subtitle.

In an embodiment of the computer program, the computer readable code means which when run on the media server causes the media server to perform the step of converting the text to a translation.

In an embodiment of the computer program, the computer readable code means which when run on the media server causes the media server to perform the step of converting the subtitles and the translation into a speech.

In an embodiment of the computer program, computer readable code means which when run on the media server causes the media server to perform the step of converting the text an advertisement for a UE-A and/or UE-B.

In an embodiment of the computer program, computer readable code means which when run on the media server causes the media server to perform the step of outputting a location based information for a UE-A and/or a UE-B.

In another aspect of the invention, there is a computer program product for the media server connected to the voice over IP (VoIP) voice communication session, the media server having a processing unit, the computer program product comprises the computer program above and a memory, wherein the computer program is stored in the memory.

There are many different examples of how the content/context of a voice call may be combined with other services, e.g. using services that are currently developed within the Internet domain—a non-exhaustive list is: real-time translation, inserting subtitles into an ongoing video stream, voice-based search engine, context-based advertising, etc.

Examples of web based applications/functions that can be added:
Allowing advertisers to respond to the context of ongoing conversations between end-users through analysis of the speech within a conversation.
Providing real-time translation or real-time subtitles for voice networks, either mobile or fixed. Similar mechanisms can be used on networks running TV over a mobile or IP connection, e.g. IPTV.
Providing an advertising mechanism based on the voice “data” (i.e. content of the conversation) services for operators to combine their strengths with those of the Internet technologies.
Providing real-time translation of the ongoing conversation, e.g. from Swedish to Mandarin and vice versa.
Providing real-time subtitles of the conversation for hearing impaired end users or translated subtitles of the conversation for an ongoing phone conference.
Providing contextual references for end-users related to their ongoing conversation. As an example, in a conversation between two end users in Narrabeen, Sydney, about water sports, it may pop up a web link to the nearby water-ski rental store. Upon clicking on this link, the end-users will be provided with a map, etc. and organize to meet at that location. This combines the “context” of the conversation “water sports” with the location mechanism of the maps service.
Providing an advertising mechanism based on the voice “data” (i.e. content of the conversation) services for operators to combine their strengths with those of the Internet technologies.

### BRIEF DESCRIPTION OF THE DRAWINGS

A more thorough understanding of the invention may be derived from the detailed description along with the figures, in which:

FIG. 1 illustrates a flow diagram of call sessions according to an embodiment of the invention.

FIG. 1a illustrates a flow diagram for an IPTV based embodiment.

FIG. 2 illustrates a flow diagram for a second embodiment.

FIG. 3 illustrates a flow diagram for a third embodiment.

FIG. 4 illustrates a detailed flow diagram for the embodiment in FIG. 3.

FIG. 4a illustrates a media server 600 according to an embodiment of the invention.

FIG. 4b illustrates a creating unit 640 of the media server 600.

FIG. 4c illustrates a voice based internet service comprising the media server 600 and the web based applications 170

FIG. 5 illustrates a flow diagram for a fourth embodiment.

FIG. 6 illustrates another aspect of the media server 600 with computer program product and computer program.

### DETAILED DESCRIPTION

The invention will now be described more in detail with the aid of embodiments in connection with the enclosed drawings.

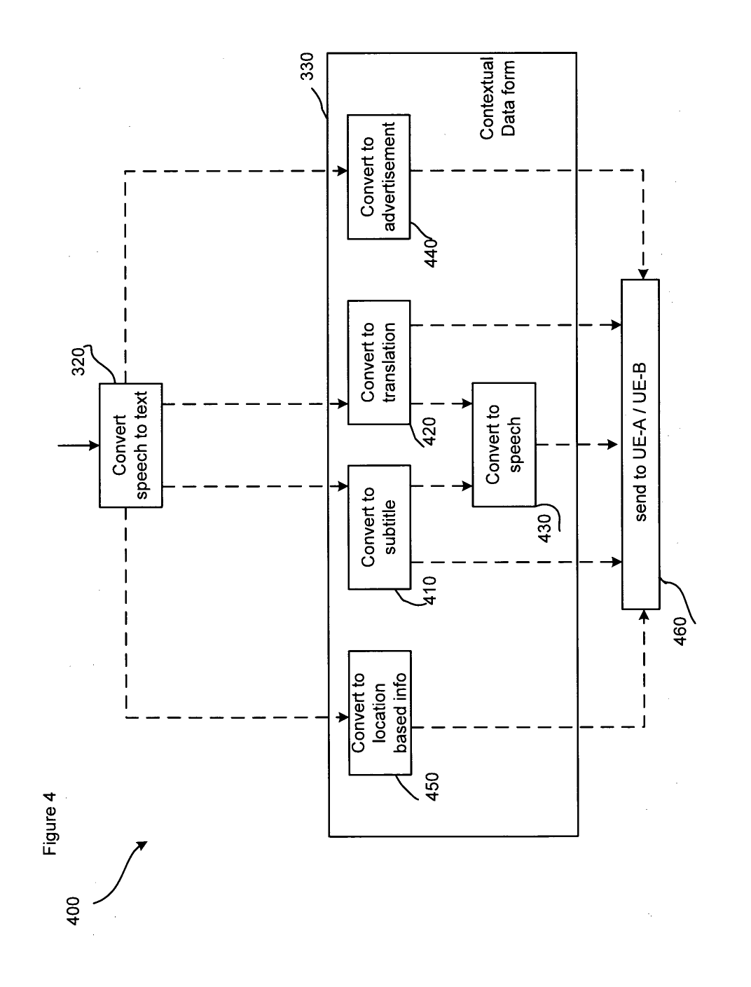

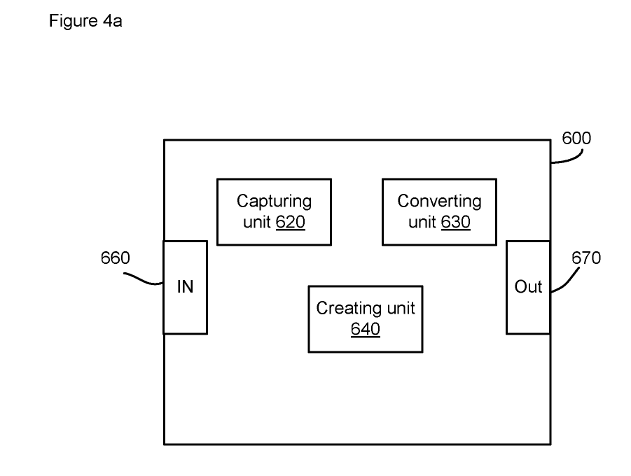

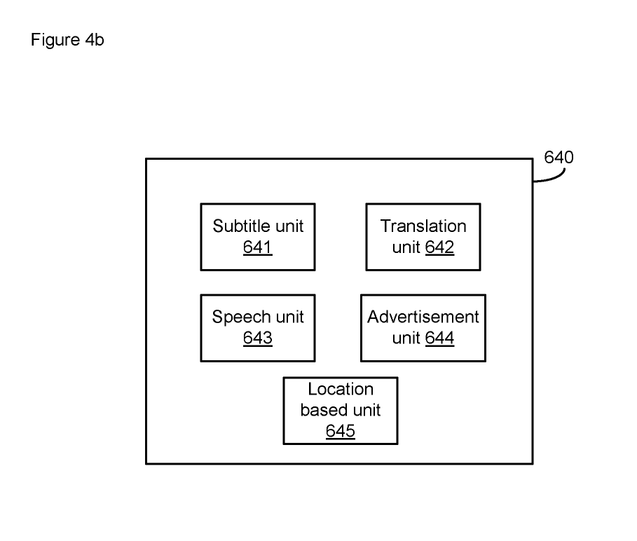

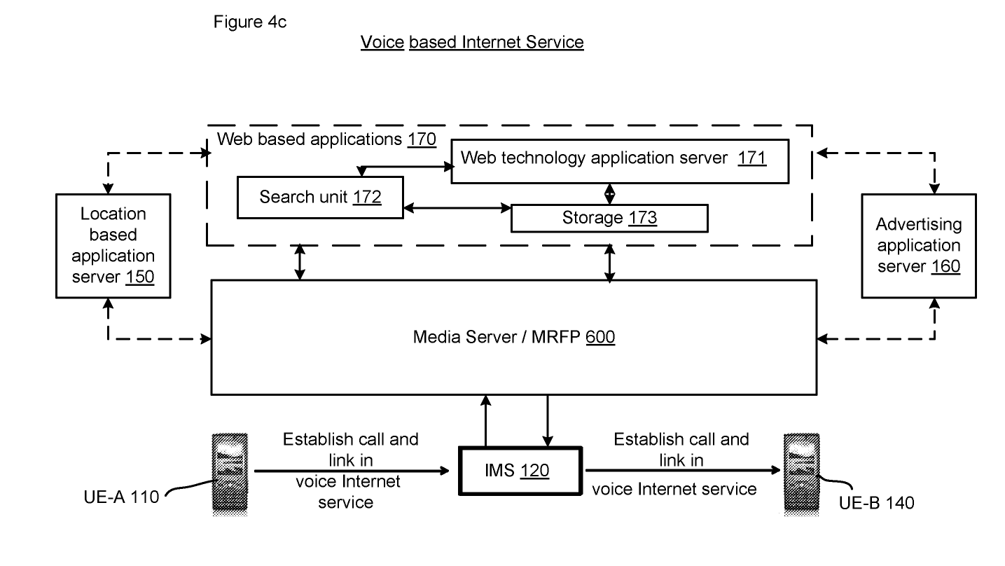

The number of web based applications is continuously growing. Examples are web based communities and hosted services, such as social-networking sites, wikis and blogs, which aim to facilitate creativity, collaboration, and sharing between users. A Web 2.0 technology is an example of such web based applications 170 (see FIG. 4c).

In an aspect of the invention a media server 600 is provided for combining a speech related to a voice over IP (VoIP) voice communication session between users, with the web based applications 170 whereby improving the voice service in a voice over IP (VoIP) session such as a Skype technology or a network architecture called IMS (IP Multimedia Subsystems) developed by the 3^{rd} Generation Partnership Project (3GPP) e.g. IMS core 120. In another aspect of the invention, a method is provided in the media server 600 for combining the speech related to the VoIP voice communication session between users, with the web based applications 170. In another aspect a computer program for the media server 600 is provided. In another aspect a computer program product for the media server 600 is provided. A concept of the invention is to capture the voice content i.e. a speech of the VoIP session i.e. in a Skype or an IMS session and “mash up”/combine the content with the web based applications 170. Several embodiments of the invention will now be described.

An end-user that wishes to use one of the services that adds value to the ongoing voice call does this by establishing a call and indicating that they wish to e.g. use subtitles for the ongoing conversation. This could be done by clicking on a web link, either from a PC, or a mobile terminal. A subtitling application would then establish a call via the IMS core 120 between a user equipment A (UE-A) 110 and a user equipment B (UE-B) 140, linking in the media server 600 e.g. a Media Resource Function Proxy/Processor (MRFP) into the voice session. For the IPTV scenario, the UE-A may also be a SET TOP Box (STB) 110a e.g. an IPTV broadcast that establishes the TV session. The speech between end users A and B is captured/intercepted by the media server 600, converted to a text, converted into a contextual data and this contextual data is passed onto the receiving user e.g. via UE-B 140. The speech to text transformation and conversion e.g. into the contextual data form could be created by services run in the Internet domain and “mashed up”/combined with the traffic e.g. voice from an IMS network. This is described in more detail in the later sections of the detailed description.

The service can be invoked by one of several methods; through provisioning Initial Filter Criteria in an HSS that links in the translation service during the call establishment to an end-user.

Alternatively, the service can be invoked using mechanisms such as the Parlay-X. Using the call direction mechanisms of these application programming interfaces (APIs), the media server 600 could analyse the call case by e.g. matching the caller-callee pair to assess which conversations need to invoke a mash-up service, e.g. translation into another language or subtitling; if the call needs translation, the IMS core 120 links in the correct media server 600, rather than forwarding the call directly to the B-party. Using this method, it is also possible for the callee party to invoke the inverse of the called party; for example, the callee gets Swedish to Mandarin translations, while the called party gets Mandarin to Swedish.

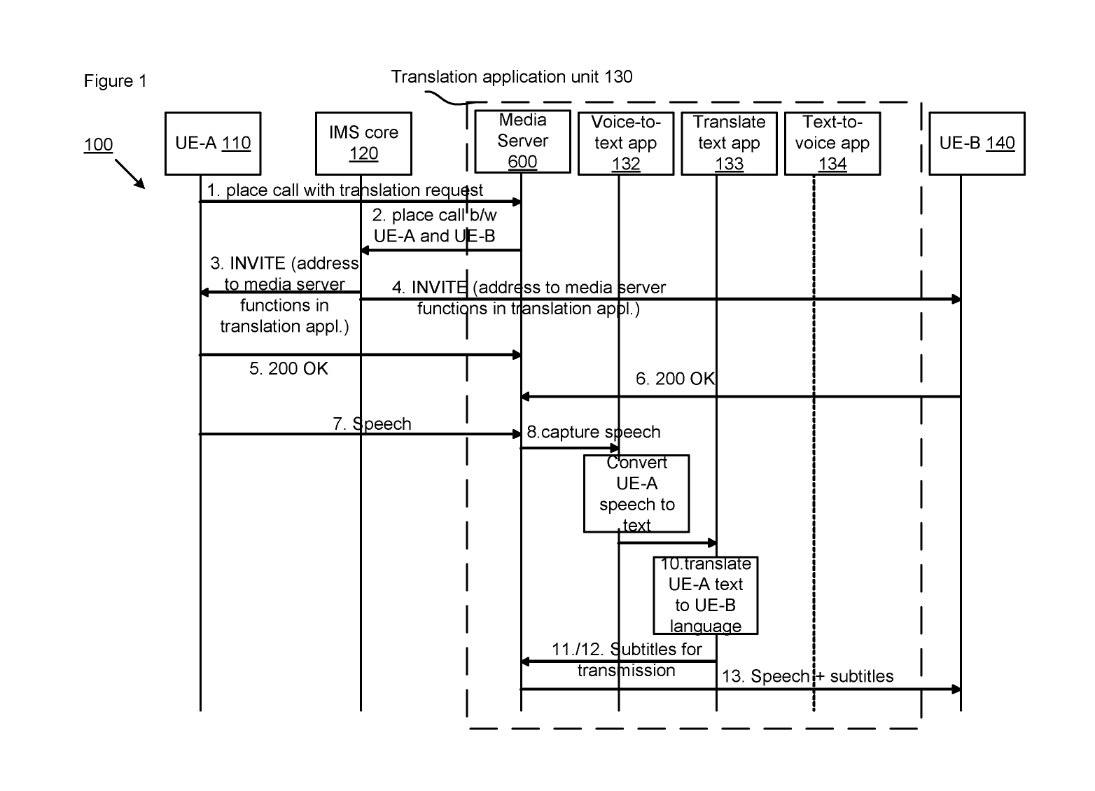

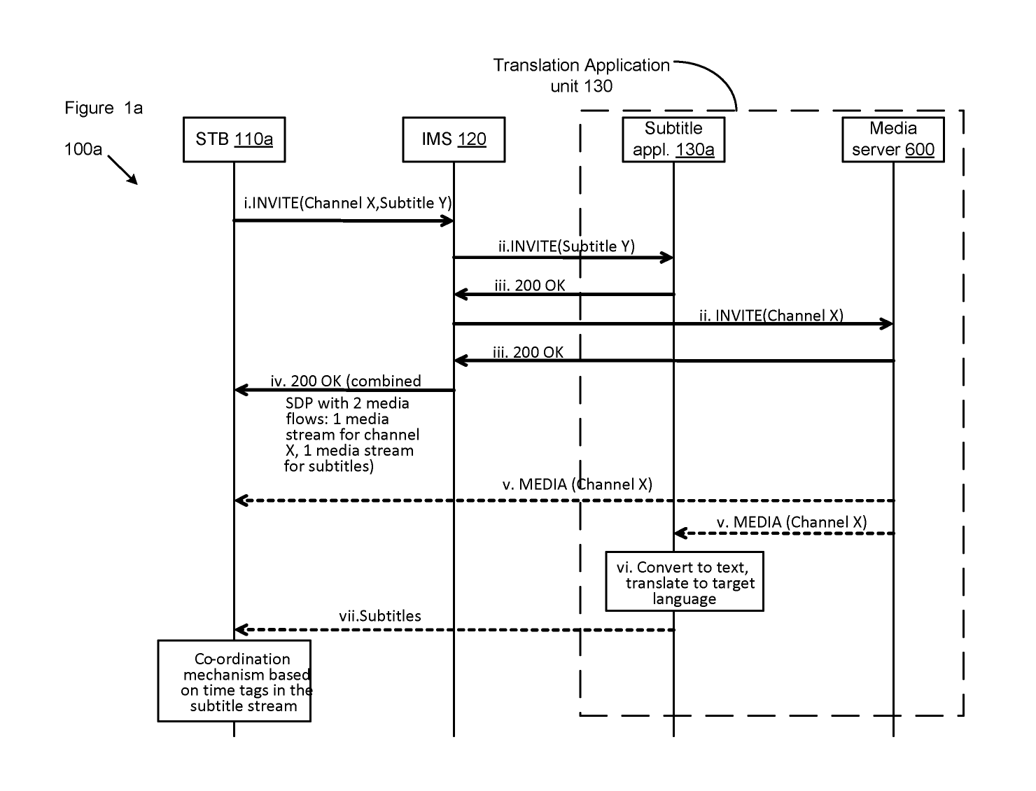

FIG. 1 illustrates a possible call flow 100 for subtitling during an IMS voice session. Other call flows are possible, based on how a service is invoked, as described in the paragraph above. The FIG. 1 comprises the following elements:
There are two user equipments, the UE-A 110 and the UE-B 140;
IMS core 120: The voice session is going through the IMS network.
a Translation application unit 130, comprising the media server 600 and the web based applications 170;
a Voice-to-text converter application 132: a voice/speech to text translator application;
a Translate text converter 133 application: an application to translate the text to another language.

In this embodiment the flow will be as follows in steps shown in FIG. 1:
1. The UE-A 110 places a call to the UE-B 140 using the Translation application unit 130 comprised in the media server 600, requesting the subtitles to be provided between e.g. Swedish and Mandarin.
2. The Translation application unit 130 contains the media server 600 functionality that performs as a Back to Back User Agent (B2BUA). The media server 600 functions establish two call legs; one to the UE-A 110 and one to the UE-B 140 by sending an INVITE message to the IMS core 120.
3. The IMS Core 120 sends an INVITE message to the UE-A 110 with the IP address and port number of the media server B2BUA.
4. The IMS Core 120 sends the INVITE message to the UE-B 140 with the IP address and port number of the media server B2BUA.
5. The UE-A 110 responds with a 200 OK message.
6. The UE-B 140 responds with the 200 OK message. Voice media now flows via the media server 600 functions of the B2BUA.
7. The end user A speaks Swedish as per normal.
8. The media server 600 captures the speech from the UE-A's call leg.
9. The media server 600 converts it to the text using the voice-to-text converter application 132. This text is the extracted text that can be mashed up with Internet technologies in the web based applications 170. The media server 600 functions as a gateway toward the web based applications 170 as shown in FIG. 4c.
10. The text thus extracted from the speech can now be converted into the contextual data by sending it to the translate text converter application 133 on the web based applications 170 whereby outputting a translation. One example is Alta vista's “babel fish”; the translation is returned in the text form in the UE-B 140's language.
11. Alternatively or in addition, the text thus extracted from the speech can now be converted into the contextual data by feeding the extracted text into e.g. Google's APIs to provide advertising that is contextual to the ongoing conversation.
12. The contextual data e.g. the subtitles are sent back to the media server 600 for transmission along with the speech/voice session.
13. The media server B2BUA sends the speech and the subtitles as a multimedia session.

For IPTV, the media server 600 captures the voice part of the video stream. The media server 600 converts the speech to text and allows the end-user to select the language of the subtitles for that program. Following steps are performed:
select a program and what language the subtitles should be provided in,
capture the speech of an IPTV communication session,
translate the speech to text,
translate said text to correct language, and
insert subtitles into the IPTV communication session.

FIG. 1a illustrates a call flow 100a for subtitling during the IPTV session. Other call flows are possible, based on how the service is invoked, as described in the paragraph above. The FIG. 1a comprises the following elements:
There is one user equipment, e.g. the STB 110a in the form of e.g. an IPTV broadcast.
There is the media server 600 that streams TV channels to the STB 110a.
IMS core 120: The IPTV session is going through the IMS network;
The Translation application unit 130, comprising the media server 600 and the web based applications 170;
a Voice-to-text converter application 132: a voice/speech to text translator application;
a Translate text converter application 133: an application to translate the text to another language;
a subtitle application 130a comprising both the voice-to-text converter application 132 and the translate text converter application 133.

In this embodiment the flow will be as follows in steps shown in FIG. 1a:
i. The STB 110a places a TV channel request to the IPTV provider using the Translation application unit 130 i.e. comprising the media server 600, requesting the subtitles to be provided e.g. Swedish or Mandarin.
ii. The IMS core 120 establish two sessions; one to the subtitle application 130a and one to the media server 600 by sending an INVITE from the IMS core 120.
iii. Both the subtitle application 130a and the media server 600 return the 200 OK message to the IMS core 120.
iv. The IMS core 120 sends the 200 OK message to the STB 110a with a combined session description protocol (SDP) with two media flows, e.g. one media stream for a channel X and one media stream for the subtitles.
v. The media server 600 sends the media e.g. channel X to the STB 110a and to the subtitle application 130a.
vi. The subtitle application 130a converts the media to text and translates to a target language.
vii. The subtitle application 130a sends the subtitles to the STB 110a. The STB 110a has co-ordination mechanism based on time tags in the incoming subtitle stream.

The above solution is also suitable to be used in conjunction with e.g. news broadcasts to provide subtitles on an IPTV service. This will provide a better configurability for the end users rather than traditional subtitling on a TV program. The end users could be able to choose exactly the language that they want to see the subtitles in.

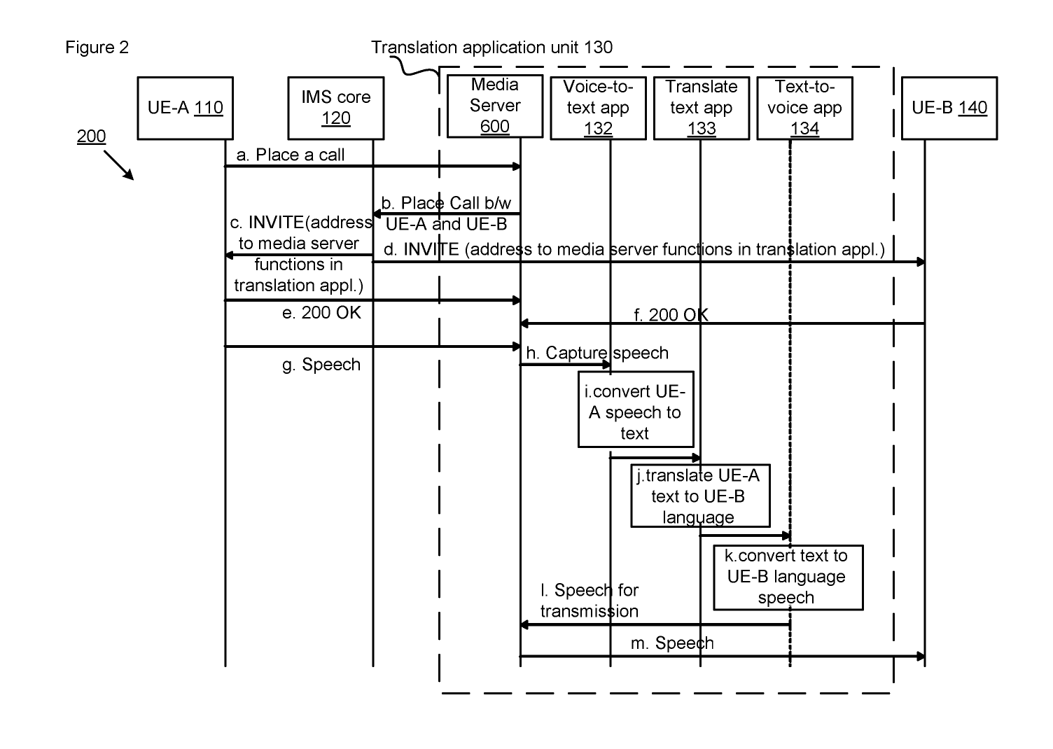

FIG. 2 illustrates a call flow 200 for translation of voice during a voice session. The FIG. 2 comprises the following elements:
There are two user equipments, the UE-A 110 and the UE-B 140.
The IMS core 120: The voice session is going through the IMS network.
The Translation application unit 130, comprising the media server 600 and the web technologies 170 functions.
The Voice-to-text converter application 132: a voice to text translator application.
The Translate text converter application 133: an application to translate the text to another language.
A Text-to-voice converter application 134: an application to a text to voice translator.

In this particular embodiment the flow will be as follows, (FIG. 2):
a) The UE-A 110 places a call to UE-B 140 using the Translation Service application 130 comprising the media server 600, requesting the subtitles to be provided between e.g. Swedish and Mandarin.
b) The Translation service application contains the media server 600 functionality that performs as the B2BUA. The media server 600 functions establish two call legs; one to the UE-A 110 and one to the UE-B 140 by sending the INVITE message to the IMS core 120.
c) The IMS Core 120 sends the INVITE message to the UE-A 110 with the IP address and port number of the media server B2BUA.
d) The IMS Core 120 sends the INVITE message to the UE-B 140 with the IP address and port number of the media server B2BUA.
e) The UE-A 110 responds with the 200 OK.
f) The UE-B 140 responds with the 200 OK. Voice media now flows via the media server 600 functions of the B2BUA.
g) End User A speaks Swedish as per normal
h) The media server 600 captures the speech from the UE-A 110's call leg.
i) The media server 600 converts it to the text using the voice-to-text converter application 132. This is the “data” that can be mashed up with Internet technologies in the web based applications 170 and form the contextual data. The media server 600 works as the gateway toward the web based applications 170 as shown in FIG. 4c.
j) This text thus extracted text from speech, can now be converted into the contextual data by sending it to the translate text converter application 133 on the web based applications 170 for conversion into contextual data. One example is Alta vista's “babel fish” for language translation; the contextual data i.e. the translation is returned in text format to in the UE-B 140's language. The contextual data is thus a language translation.
k) The contextual data i.e. the translation thus retrieved from the mash-up/combining is converted back to a translated speech in the selected language using the text-to-speech converter application 134.
l) OK message for the translated speech for transmission.
m) The media server B2BUA sends the translated speech to the UE-B 140.

Similar methods could be used for different other solutions, e.g. linking in subtitles for live broadcasts on the TV etc.

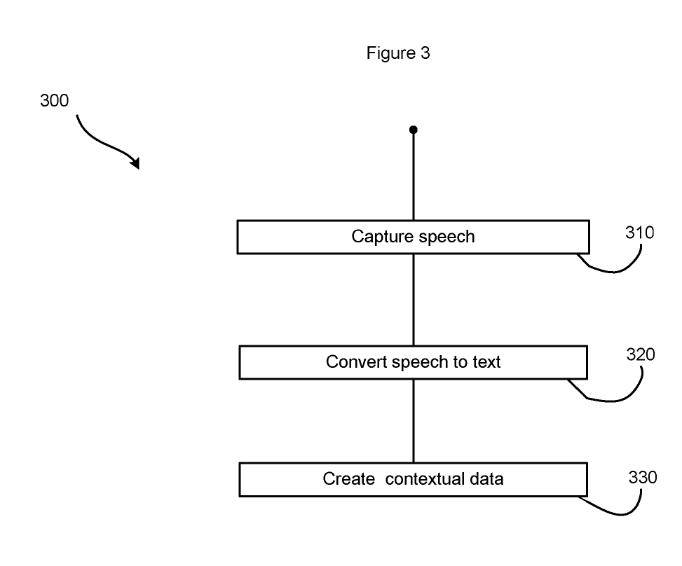

FIG. 3 describes procedural steps 300 performed by the media server 600, for combining the speech related to the VoIP voice communication session such as a IMS based voice communication session between the UE-A 110 and the UE-B 140, with the web based applications 170. In procedure 300, the media server 600 performs the following steps for the combining of the IMS voice communication session with the web based applications 170. In first step 310, the media server 600 captures the speech related to the IMS voice communication session. The initialization procedure is initiated by UE-A 110/UE-B 140 as described earlier in the steps 1-7 and the capturing process in step 8 in the FIG. 1 and similarly by the steps a-g in FIG. 2. In second step 320, the media server 600 converts the speech to a text; i.e. the step 9 in FIG. 1 and the step i in the FIG. 2. In third step 330, the media server 600 creates the contextual data by adding a service from the web based applications 170 using the text. The creation of the contextual data and subsequent transfer of the contextual data to the UE-A 110 and/or the UE-B 140 is performed i.e. in the steps 10-12 in FIG. 1 and steps j-m in FIG. 2.

The invention allows greater value to be derived from an IMS connectivity by retrieving the voice data from the ongoing voice session. This conversational data i.e. the extracted text is then used to provide greater value to the end-users of the IMS core 120 by mashing up this data with the web based applications 170, e.g. the web 2.0 technologies.

FIG. 4 describes schematically a flow 400, different forms pertaining to the extracted text being converted to the contextual data e.g. in steps 320, 330 of FIG. 3 among others. In step 410, the media server 600 in combination with web based applications 170 may convert the text to subtitles. In step 420, the media server 600 in combination with the web based applications 170 may convert the text to the translation e.g. into a different language. In step 430, the media server 600 in combination with the web based applications 170 may convert the subtitles and the translation into the speech. In step 440, the text may be sent to an advertising application server 160 which converts the text to meaningful advertisements i.e. the contextual text for the user. In step 450, the text may be sent to a location based application server 150 to output e.g. location based information for the user. Further in step 460, the output from steps 410-450 are sent to the user. The steps 410-450 maybe performed individually or in combination as an output to the user.

FIG. 4a shows schematically an embodiment of the media server 600. The media server 600 has a
Capturing unit that performs the step 310;
Converting unit 630 that performs the step 320;
Creating unit 640 that performs the step 330,
An input unit 660 and an output unit 670.

Further shown in FIG. 4b, the creating unit 640 has a
Subtitle unit 641 that performs the step 410;
Translation unit 642 that performs the step 420;
Speech unit 643 that performs the step 430;
Advertisement unit 644 that performs the step 440; and
Location based unit 641 that performs the step 450.

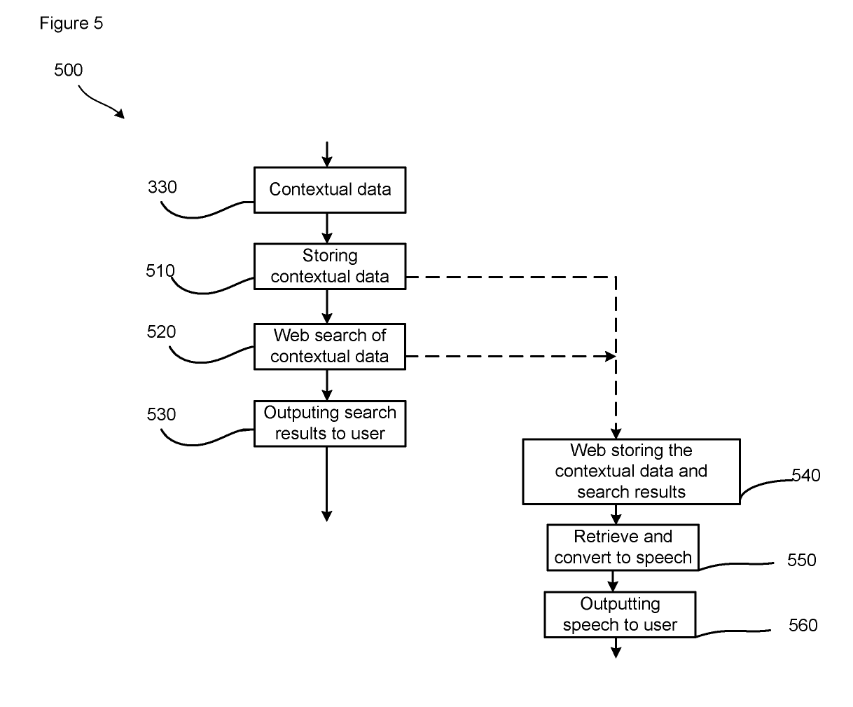

FIG. 4c describes schematically another embodiment of the invention. The FIG. 4c shows the functional relationship between the media server 600 and the web based applications 170 to create a voice based internet service. Further the location based application server 150 and the advertising application server 160 may either be connected to the web based applications 170 or the media server 600. The process of such voice based internet service is described later on in FIG. 5. It will be appreciated that other devices e.g. the web based applications 170 may include some of similar components of the media server 600 shown in FIGS. 4a and 4b. The web based applications 170 may comprise a search unit 172 and a storage unit 173.

In order for the invention to be used to create the voice-based Internet Platform, a call would be established via the IMS core 120 that links in the “voice-based Internet Service”. This service would provide the following functionality:
The ability to store the content of the ongoing voice sessions as part of the voice corpora using i.e. the web based applications 170. This would enable a web-page to be constructed entirely out of voice to be created.
The ability to search the content of the voice, video or other multimedia corpora and return a set of web link pages that maybe of interest for the end users.
The ability to convert voice content to text and store it as part of the Internet's traditional text-based corpora/web viewing format.
The mechanism to convert the text corpora to speech for playback to end-users who cannot e.g. read the web page.

This service may be used as the basis of several different types of application, for example:
Storage of voice communications with institutions, such as banks, which may form the basis of a formal contract for illiterate end-users that they can store and place tags on so they can search through it at a later date in order to find particular parts of the contract relevant at that point in time.
End-users may submit voice-based ‘web-pages’ to be stored in the multimedia corpora for others to be able to use. For example, someone records a voice web page about “Drip Irrigation for use in drought affected areas”, instead of typing the content they speak the content into their phone or other IMS terminal. The end-user indicates that they are finished recording their message and the service then prompts the end-user to submit keywords to describe the piece. In this example, it could be “drought”, “irrigation”, “minimise use of water”, “minimise use of fertiliser”, etc. This is then captured by the service and stored in an appropriate format.
Voice can be saved either in a server accessible for the public on the ‘public’ Internet or in a ‘private’ network. For recording a telephone call, the private storage area could be based within the Operator's network.
If the end-user wishes, they can also indicate that they wish for the voice-based web page to be converted to text and stored on the Internet in text-based format for those that may wish to read it, rather than listen to it.
Voice or other multimedia corpora can then be searched using several different mechanisms; XML, or other Natural Language Processing (NLP) mechanisms.
Finally, using the voice-based Internet service, the end-users may utilise the service to search text-based corpora and have the text converted to speech.

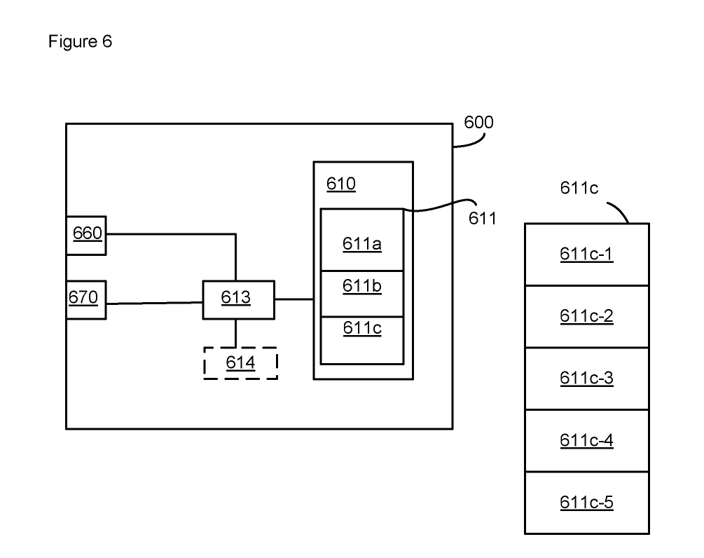

FIG. 5 describes very schematically a procedure flow 500, with numerous other embodiments relating to storing, retrieving and converting the contextual data. In a first step 510, the contextual data may be stored in a web technology application server 171 e.g. Internet or IP-based application server. In a second step 520, stored content of the contextual data may be searched on the web e.g. by the search unit 172 in assistance with the web technology application server 171. In a third step 530, the media server 600 in combination with the web based applications 170, may output and return to the UE-A 110 and/or UE-B 140 a list of web page links from searching the content of the contextual data. In step 540, the search results and the contextual data may be stored on the web e.g. on the web technology application server 171. In step 550, the contextual data may be retrieved and converted by the media server 600 to the translated speech which subsequently may be stored e.g. on the web technology application server 171 for later viewing and access. In step 560, the translated speech maybe is output to the user for playback. In an alternative embodiment the storage unit 173 maybe utilized for steps 510 and 540 described earlier. The storage unit 173 may utilize cloud computing for storage optimization. In an alternative embodiment a media server storage unit 614 maybe utilized for steps 510 and 540 described earlier as shown in FIG. 6. The search unit 172 has access to both stored user data in the media server storage unit 614 and the storage unit 173.

FIG. 6 shows schematically an embodiment of the media server 600. Comprised in the media server 600, a processing unit 613 e.g. with a DSP (Digital Signal Processor) and an encoding and a decoding modules. The processing unit 613 can be a single unit or a plurality of units to perform different steps of procedure 300,400 and 500. The media server 600 also comprises the input unit 660 and the output unit 670 for communication with the IMS core 120, the web based applications 170, the location based application server 150 and the advertising application server 160. The input unit 660 and output unit 670 may be arranged as one port/in one connector in the hardware of the media server 600.

Furthermore the media server 600 comprises at least one computer program product 610 in the form of a non-volatile memory, e.g. an EEPROM and a flash memory or a disk drive. The computer program product 610 comprises a computer program 611, which comprises computer readable code means which when run on the media server 600 causes the media server 600 to perform the steps of the procedure 300, 400 and 500 described earlier.

Hence in the exemplary embodiments described earlier, the computer readable code means in the computer program 611 of the media server 600 comprises a capturing module 611a for capturing the speech of the IMS voice session; a converting module 611b for converting the speech to text; and a creating module 611c for adding the service from web based applications 170 using the text, in the form of computer program code structured in computer program modules. The modules 611a-c essentially performs the steps of flow 300 to emulate the device described in FIG. 4a. In other words, when the different modules 611a-c are run on the processing unit 613, they correspond to the corresponding units 620, 630, 640 of FIG. 4a.

Further the creating module 611c may comprise a location based module 611c-1 for converting the text to subtitles; a translation module 611c-2 for converting the text to the translation e.g. into different languages; a speech module 611c-3 for converting the subtitles and the translation into the speech; an advertisement module 611c-4 for converting the text to meaningful advertisement for the user; and a location based module 611c-5 for outputting location based information for the user, in the form of computer program code structured in computer program modules. The modules 611c-1 to 611c-5 essentially performs the steps of flow 400 to emulate the device described in FIG. 4b. In other words, when the different modules 611c-1 to 611c-5 are run on the processing unit 613, they correspond to the corresponding units 641-645 of FIG. 4b.

Although the computer readable code means in the embodiments disclosed above in conjunction with FIG. 6 are implemented as computer program modules which when run on the media server 600 causes the media server 600 to perform steps described e.g. earlier in the conjunction with figures mentioned above. At least one of the corresponding functions of the computer readable code means maybe implemented at least partly as hardware circuits in the alternative embodiments described earlier. The computer readable code means may be implemented within the media server database 610.

The invention is of course not limited to the above described and in the drawings shown embodiments.

1. A method, in a media server, for combining a speech related to a voice over IP (VoIP) voice communication session between a user equipment A (UE-A) and a user equipment B (UE-B), with a web based applications, the method further comprising the media server performing the following steps:
capturing the speech related to the VoIP voice communication session;
converting the speech to a text;
creating a contextual data by adding a service from the web based applications using the text.

2. A method according to claim 1, wherein the contextual data is a subtitle, the method further comprising the step of sending the subtitle to the UE-B.

3. A method according to claim 1, wherein the contextual data is a translation, the method further comprising the step of sending the translation to the UE-B.

4. A method according to claim 3, further comprising the steps of
converting the translation into a translated speech;
sending the translated speech to the UE-B.

5. A method according to claim 1, wherein the step of creating a contextual data comprises the sub-steps of
sending the text to an advertising application server;
receiving the contextual text in the form of an advertisement
sending the advertisement to UE-B and/or UE-A.

6. A method according to any one of claims 1 to 5, wherein the UE-A is a set top box.

7. A method according to any one of claims 1 to 6, comprising the step of providing the contextual data in real-time to the UE-A and/or UE-B.

8. A method according to claim 2, comprising the step of providing a real-time output of the subtitles in parallel of an IMS voice session.

9. A method according to claim 3, comprising the step of providing a real-time output of the translation in parallel of an IMS voice session.

10. A method according to claim 4, comprising the step of providing a real-time output of the translated speech to the UE-B.

11. A method according to claim 1, wherein the step of creating a contextual data further comprises the sub-steps of
sending the text to a location based services application server;
receiving the contextual text in the form of a location information;
sending the location information to the UE-B and/or UE-A.

12. A method according to any one of claims 1 to 6, further comprising the step of storing the contextual data in a web technology application server.

13. A method according to claim 12, comprising the steps of
requesting a search of the content of the contextual data from a search unit;
receiving a list of web page links from the search; and
outputting and returning to the UE-A and/or UE-B with the list of web page links from the search.

14. A method according to claim 12 or 13, comprises a step of storing the contextual data and/or the web page links as an internet text based corpora/web viewing format, the step of storing maybe done in a web technology application server and/or a storage unit 173 and/or a media server storage unit 614.

15. A method according to claims 12 to 14, further comprising the steps of:
retrieving the contextual data from the web technology application server; and
converting the contextual data into the translated speech for playback for the UE-A and/or UE-B.

16. A media server, for combining a speech related to a voice over IP (VoIP) voice communication session between a user equipment A (UE-A) and a user equipment B (UE-B), with a web based applications, the media server comprising:
a capturing unit for capturing the speech of the VoIP voice communication session;
a converting unit for converting the speech to text;
a creating unit for creating a contextual data by adding a service from web based applications using said text.

17. A media server according to claim 16, the media server comprising:
a subtitle unit for converting the text to subtitles; and
an output unit for sending the subtitle to the UE-B.

18. A media server according to claim 16, the media server comprising:
a translation unit for converting the text to a translation; and
an output unit for sending the translation to the UE-B.

19. A media server according to claim 18, the media server comprising:
a speech unit for converting the translation into a translated speech; and
an output unit for sending the translation to the UE-B.

20. A media server according to claim 16, the media server comprising:
an advertisement unit for sending the text to an advertising application server;
an input unit for receiving the contextual text in the form of an advertisement; and
an output unit for sending the advertisement to UE-B and/or UE-A.

21. A media server according to claims 16 to 20, wherein the UE-A is a set top box.

22. A media server according to claims 16 to 21, comprising that the media server provides the contextual data in real-time to the UE-A and/or UE-B.

23. A media server according to claim 17, comprising that the media server provides a real-time output of the subtitles in parallel of an IMS voice session.

24. A media server according to claim 18, comprising that the media server provides a real-time output of the translation in parallel of an IMS voice session.

25. A media server according to claim 19, comprising that the media server provides a real-time output of the translated speech to the UE-B.

26. A media server according to claim 16, the media server comprising:
a location based unit for sending the text to a location based services application server;
an input unit for receiving the contextual text in the form of a location information; and
an output unit for sending the location information to the UE-B and/or UE-A.

27. A media server according to claims 16 to 21, the media server comprising the output unit for sending the contextual data for storage on a web technology application server and/or storage unit 173 and/or a media server storage unit 614.

28. A media server according to claim 27, the media server comprising:
the output unit for requesting a search of the content of the contextual data from a search unit;
the input unit for receiving a list of web page links from the search; and
the output unit for outputting and returning to the UE-A and/or UE-B with the list of the web page links from the search.

29. A media server according to claim 27 or 28, the media server comprising the output unit for sending the contextual data and/or the list of web page links as an internet based corpora/web viewing format for storage on the web technology application server.

30. A media server according to claims 27 to 29, the media server comprising:
the input unit for retrieving the contextual data from the web technology application server; and
the speech unit for converting the contextual data into the translated speech for playback for the UE-A and/or UE-B.

31. A computer program comprising computer readable code means which when run on a media server causes the media server to perform the steps of:
capture a speech related to a voice over IP (VoIP) voice communication session;
translate the speech to a text;
create a contextual data by adding a service from a web based applications using the text.

32. A computer program according to claim 31, comprising computer readable code means which when run on the media server causes the media server to perform the step of converting the text to a subtitle.

33. A computer program according to claim 31 comprising computer readable code means which when run on the media server causes the media server to perform the step of converting the text to a translation.

34. A computer program according to claims 32 and 33, comprising computer readable code means which when run on the media server causes the media server to perform the step of converting the subtitles and the translation into a speech.

35. A computer program according to claim 31, comprising computer readable code means which when run on the media server causes the media server to perform the step of converting the text an advertisement for a user equipment A (UE-A) and/or a user equipment B (UE-B).

36. A computer program according to claim 31, comprising computer readable code means which when run on the media server causes the media server to perform the step of outputting a location based information for a user equipment A (UE-A) and/or a user equipment B (UE-B).

37. A computer program product for a media server connected to a voice over IP (VoIP) voice communication session, the computer program product comprises a computer program according to anyone of claims 31 to 36 and a memory, wherein the computer program is stored in the memory.
